(19) United States
(12) Patent Application Publication
(10) Pub. No.: US 2009/0238558 A1
(43) Pub. Date: Sep. 24, 2009

(54) STATION TERMINAL DEVICE, COMMUNICATION SYSTEM, SUBSCRIBER DEVICE MANAGEMENT METHOD, AND RECORDING MEDIUM RECORDING PROGRAM FOR STATION TERMINAL DEVICE

(76) Inventors: HITOSHI KATAYAMA, Tokyo (JP); Yoshinori Tsukahara, Tokyo (JP)

Correspondence Address: NEC CORPORATION OF AMERICA, 6535 N. STATE HWY 161, IRVING, TX, 75039, US

(21) Appl. No.: 12/403,928

(22) Filed: Mar. 13, 2009

(30) Foreign Application Priority Data
Mar. 21, 2008 (JP) 2008-073979

(51) Int. Cl. H04B 10/08; G08B 17/12

(52) U.S. Cl. 398/16; 340/600

(57) ABSTRACT

In a conventional art, ONUs in services are significantly affected even when just one ONU is activated, and thus a communication bandwidth fails to be effectively utilized. To address this, an OLT includes a first distance information storing unit that stores information on the distance to an ONU in association with identification information which identifies the ONU (ONUi), and by using the distance information stored in the first distance information storing unit, an activation control unit controls activation of the ONUi.

This application is based upon and claims the benefit of priority from Japanese patent application No. 2008-073979, filed on Mar. 21, 2008, the disclosure of which is incorporated herein in its entirety by reference.

### BACKGROUND OF THE INVENTION

1. Field of the Invention

The present invention relates to a station terminal device which is used such that a subscriber terminal device is connected to the station terminal device and the station terminal device manages the subscriber terminal device in a Passive Optical Network (PON) system, for example, a communication system, a subscriber device management method, and a recording medium recording a program for the station terminal device.

2. Description of Related Art

As a growing number of access networks are optically implemented in these years, the PON system is gaining widespread use around the world. Under such circumstances, it is increasingly important to operate a PON system with high efficiency.

A PON system is generally composed of an Optical Line Termination (OLT or station optical network terminal device) and a subscriber optical network terminal device called an Optical Network Unit (ONU) or an Optical Network Termination (ONT) (hereinafter referred to as an ONU) which are connected to each other.

As a technique relating to the present invention, an OLT can transmit a signal for delay measurement to the nth subscriber line device, and if the measurement of delay succeeds, transmit a signal for delay measurement to the n+1th subscriber line device while transmitting a measured value of delay to the nth subscriber line device, thereby shortening activation time of subscriber devices on the whole (see Japanese Patent Laid Open Publication No. 2000-216803, for instance).

As another technique relating to the present invention, a station device can transmit a request for issuing a distance measurement signal to a subscriber device and, upon recognizing a distance measurement signal sent back from the subscriber device, calculate the logical transmission distance between itself and the subscriber device based on the time of the recognition (see Japanese Patent Laid Open Publication No. 2003-18174, for instance).

Problems associated with the conventional techniques above are shown next.

First, as to activation of an ONU, G984.3 of ITU-T Recommendation specifies that an ONU in service temporarily stops transmission when distance measurement is performed for activating a new ONU. When position information (or the distance) of the newly connected ONU is not known, the stop time is determined according to the maximum difference distance of a PON. By way of example, when the maximum distance of a PON system to be applied is 20 km, it is necessary to provide a service unavailable time corresponding to the distance range of 0 to 20 km.

IEEE802.3ah, which is another method of ONU activation, establishes a periodical stop time on ONUs in service for activation of an ONU. However, this periodical stop time is also determined according to the maximum difference distance of a PON just as in the ITU-TG 984.3 described above. Accordingly, when an approximate distance between an OLT and an ONU in a PON system is not known in advance, a service unavailable time corresponding to the maximum distance range has to be provided as mentioned above. This leads to a problem of bandwidth equivalent to the service unavailable time being not effectively utilized.

The technique described in Japanese Patent Laid Open Publication No. 2000-216803 is intended to shorten activation time required for activating a large number of subscriber devices at a time and does not provide for reduction of influence on other ONUs in service when just one ONU is activated.

Also, the technique of Japanese Patent Laid Open Publication No. 2003-18174 is intended to enable measurement of the transmission distance between an OLT and an ONU without the OLT having to periodically set a predefined time length for receiving a distance measurement signal from the ONU and does not consider reduction of influence on other ONUs in service at the time of ONU activation.

### SUMMARY

The present invention is intended to solve the above-mentioned problems. To this end, an object thereof is to provide a station terminal device, communication system, subscriber device management method, and a recording medium recording a program for the station terminal device which can reduce influence of other ONUs in service and effectively utilize a communication bandwidth even when one ONU is activated.

To attain the object, a station terminal device according to the present invention includes a first distance information storing unit that stores distance information on a distance to a subscriber terminal device in association with identification information that identifies the subscriber terminal device; and an activation control unit that uses distance information stored in the first distance information storing unit to control activation of a subscriber terminal device that is identified by identification information associated with the distance information.

A communication system according to the present invention is composed of the station terminal device described above connected with the subscriber terminal device via a transmission channel.

A subscriber device management method according to the present invention includes a first distance information storing step of storing distance information on a distance to a subscriber terminal device in association with identification information that identifies the subscriber terminal device; and an activation control step of using distance information stored at the first distance information storing step to control activation of a subscriber terminal device that is identified by identification information associated with the distance information.

A recording medium recording a program for a station terminal device according to the present invention records a program for causing a computer to execute a first distance information storing process for storing, in storing unit, distance information on a distance to a subscriber terminal device in association with identification information that identifies the subscriber terminal device; and an activation control process for using distance information stored in the first distance information storing process to control activation of a subscriber terminal device that is identified by identification information associated with the distance information.

### BRIEF DESCRIPTION OF THE DRAWINGS

FIG. 1 generally shows an OLT as an exemplary embodiment of the present invention;

FIG. 2 shows an exemplary configuration of a PON system as the present embodiment;

FIG. 3 shows an exemplary configuration of OLT 1 as the present embodiment;

FIG. 4 is a flowchart illustrating operations for optimizing a bandwidth to be allocated to an activated ONU at the time of ONU activation; and

FIG. 5 is a flowchart illustrating operations for locating the point of a failure at the time of line failure occurrence.

### EXEMPLARY EMBODIMENT

Now, an exemplary embodiment of the station terminal device, communication system, subscriber device management method, and the program for the station terminal device according to the present invention as applied to a PON system will be described in detail using drawings.

The overview of this embodiment will be first shown.

An OLT as the present embodiment includes first distance information storing means that stores information on the distance to an ONU in association with identification information for identifying the particular ONU (ONUi) as shown in FIG. 1, and activation control means controls activation of the ONUi using distance information stored in the first distance information storing means. Since the necessity of distance measurement at the time of activating ONUi is eliminated by the OLT storing information on the distance to the ONUi, influence on other ONUs in service, such as stop of services due to measurement of distance, can be reduced even when the ONUi is activated.

The PON system as the present embodiment includes a light source inside the OLT of the PON system that has a wavelength different from those of up, down, and VIDEO signals used in a conventional PON system, and distance measuring function using the light source. This provides the present embodiment with two features as follows.

A first feature is the ability to measure the distance to a new ONU with no influence on other ONUs that are performing communication by using the present function before activating the new ONU when optical fiber is installed to where the ONU is set up. Thus, it is possible to minimize time for which other ONUs in the same PON system are once halted or a periodical stop time for activation of an ONU, reduce as much influence on ONUs performing communication as possible, and eliminate wasting of bandwidth at the time of ONU activation.

A second feature is that when a failure of an optical cable, such as line disconnection, has occurred between certain ONUs, it enables quick recovery from the failure by measuring the distance to the failure with no influence on other ONUs performing communication and supplying information on not only the line disconnection but the distance to the point of the failure to a telecommunication operator.

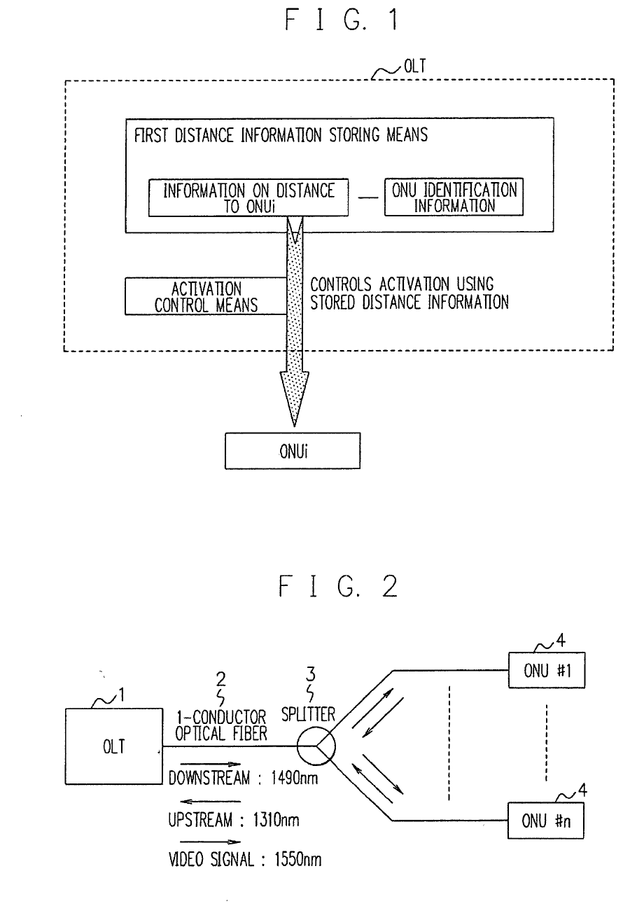

Next, the configuration of the PON system as the present embodiment will be described with reference to FIG. 2.

As illustrated in FIG. 2, the PON system according to the present embodiment includes an OLT (a station terminal device) 1 which is operated by a service provider and an ONU (an optical communication device of the other party of communication) 4 used by a user (one who utilizes services), which are connected to each other via optical fiber (transmission channel) 2 and a splitter (or connection splitting means) 3. The splitter 3 divides and transmits a down signal sent from the OLT 1 to all ONUs 4 and also multiplexes up signals transmitted from the ONUs 4 and transmits the multiplexed signal to the OLT 1.

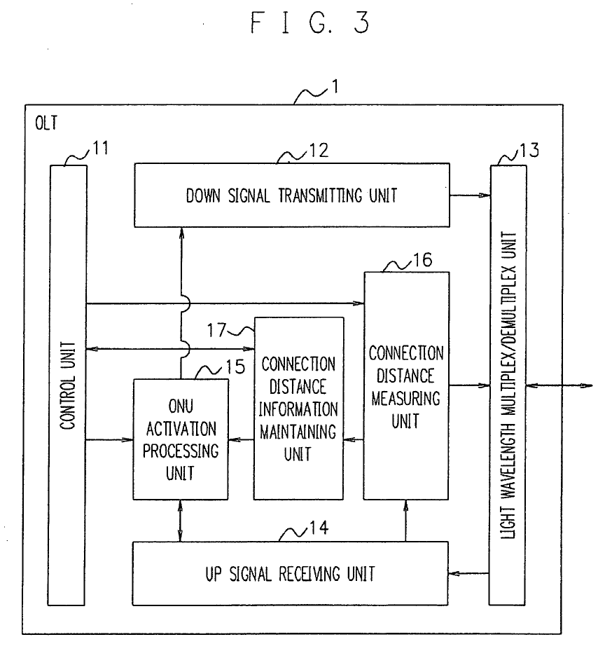

Now, the configuration of the OLT 1 in the system of FIG. 2 will be described with reference to FIG. 3.

The OLT 1 as the present embodiment includes a control unit 11 for providing various instructions and controls, a down signal transmitting unit 12 for transmitting down signals to the PON system, an up signal receiving unit 14 for receiving up signals from the PON system, a connection distance measuring unit 16 for measuring distance by means of a light source having a wavelength different from those of up and down signals before activation of an ONU, a light wavelength multiplex/demultiplex unit 13 for multiplexing and demultiplexing up/down signals and optical signals from the connection distance measuring unit, a connection distance information maintaining unit (first and second storing means) 17 for maintaining a result of measurement of the distance to an ONU or the distance to a point of a failure measured by the connection distance measuring unit and for notifying the control unit of such results or maintaining distance information input from the control unit, and an ONU activation processing unit 15 which is used for normal ONU activation or distance measurement.

As described, a major characteristic of the OLT 1 as the present embodiment includes the connection distance measuring unit 16 that uses a light source with a different wavelength from those of up and down signals, and the connection distance information maintaining unit 17.

Before activating the ONU 4 connected via the optical fiber 2 and the splitter 3 as the PON system, the OLT 1 measures the distance to the ONU 4 to be activated and gives the result of measurement to the ONU activation processing unit 15 in advance. This can decrease a bandwidth required at the time of activating the ONU 4 and eliminate wasting of bandwidth.

In a similar manner, the OLT 1 also measures the distance to a point where a failure has occurred as the PON system in the event of a line failure by using -the connection distance measuring unit 16 and the connection distance information maintaining unit 17 described above and supplies the result of measurement to the control unit 11. This enables quick location of the point of a failure as a PON system.

The configuration of the present invention has been described in detail, but the ONU activation method defined by G.984.3 of ITU-T Recommendation or the one defined by IEEE802.3ah will be not described in detail herein because they are well known to those skilled in the art and do not directly relate to the present invention.

Next, operations of the PON system as the present embodiment will be described.

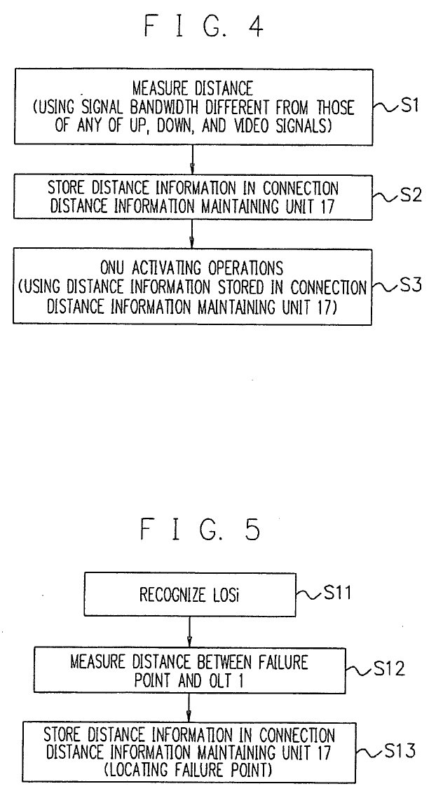

First, operations of optimizing a bandwidth to be allocated to an activated ONU at the time of activation thereof will be described with reference to FIG. 4.

The OLT 1 shown in FIG. 3 is a line termination panel in a station that communicates with the ONU 4 in the PON system. Wavelengths defined for various types of PON systems are 1490 nm for down signals and 1310 nm for up signals, and 1550 nm is generally used as a signal bandwidth for video as shown in FIG. 2.

To measure the distance to an ONU 4 before activating the ONU 4, the control unit 11 issues an instruction for distance measurement to the connection distance measuring unit 16. The connection distance measuring unit 16 measures the distance by using a signal bandwidth that is different from that of any of the up, down, and video signals shown above, e.g., 1650 nm (step S1). It is therefore possible to measure the distance between the ONU 4 as the target of distance measurement and the OLT 1 without affecting ONUs in operation in the PON system.

The distance may be measured using any of various methods, such as performing level measurement using Fresnel reflection to calculate the distance between the OLT and the ONU from the measured level value, for example. After calculating the distance to the ONU 4, the connection distance measuring unit 16 stores distance information which is the result of calculation in the connection distance information maintaining unit 17 in association with ONIJ identification information that identifies the ONU for which the distance has been measured (step S2).

The distance data and ONU identification information stored in the connection distance information maintaining unit 17 are supplied to the ONU activation processing unit 15, which is capable of connecting an ONU to a conventional PON.

Thereafter, the control unit 11 gives an instruction to the ONU activation processing unit 15 to perform normal ONU activation operations that are standardized by G.984.3 of ITU-T Recommendation and/or IEEE802.3ah. Here, the ONU activation processing unit 15 carries out activating operations for the ONU 4 which is identified by the ONU identification information by using the distance measurement result notified in advance as mentioned above (step S3).

Here, if distance setting prior to ONU connection according to the present invention is not applied to the ONU activation operations according to G.984 of ITU-T Recommendation, for example, an ONU stop time of about 200 μs (microseconds) would be necessary because the standard requires that ONU activation operations corresponding to a distance range of 0 to 20 km be performed. The ONU stop time is calculated as shown below as a time required for making a roundtrip over a distance of 20 kilometers at the speed of light, c, on the assumption that the optical fiber core has a refractive index, n=1.47.

c/n=2.9979×10⁸/1.47=2.04×10⁸ (m/s)

20000 m×2/2.04×10⁸=196.1 μs

On the other hand, when the present embodiment is applied, the ONU stop period can be shortened by locating the ONU position. For example, when an ONU which is to be activated is present within a range of 12 to 15 km as determined by measurement, the ONU stop period should be set to approximately 30 μs (microseconds) as the time required for normal ONU activation operations for a 3-kilometer distance range because the stop time depends on the maximum difference distance of a PON. The ONU stop time is calculated as shown below as the time required for making a roundtrip over a distance of 3 kilometers at the speed of light, c, by using “c/n”, which was described above:

3000 m×2/2.04×10⁸=29.4 Ps

As shown above, according to the present embodiment, a bandwidth can be effectively utilized because stop time on other ONUs can be shortened.

Similarly, when a telecommunication operator knows the distance between the OLT and an ONU in advance and/or when an installation company actually measures the distance between the OLT and the ONU, instead of measurement using the connection distance measuring unit 16, by storing the result of measurement of distance data in the connection distance information maintaining unit 17 in association with ONU identification information via the control unit 11, stop time of other ONUs at the time of activation of an ONU can also be shortened and wasting of bandwidth can be eliminated.

Next, operations of locating a point where a failure has occurred in the event of a line failure in the PON system as the present embodiment will be described with reference to FIG. 5.

G.984 of ITU-T Recommendation, for example, specifies that the OLT 1 always performs line failure monitoring to check for line disconnections. Thus, when a line disconnection has occurred between the OLT 1 and a particular ONU (ONUi), the OLT 1 recognizes Loss of Signal of ONUi (LOSi), which is an alarm signal indicating between which ONU and the OLT 1 and the line disconnection has occurred (step S11).

Upon recognizing LOSi, the control unit 11 instructs the connection distance measuring unit 16 to measure the distance in order to locate the point of the failure where the line disconnection is occurring. The connection distance measuring unit 16 measures the distance between the point of the failure and the OLT 1 in the above-described manner in the direction of ONUi identified by the LOSi (step S12). After the measurement, the connection distance measuring unit 16 stores distance information, which is the result of calculation, in the connection distance information maintaining unit 17 in association with ONU direction identification information for identifying the ONUi that indicates the direction in which the distance measurement was done (step S13). The distance data and ONU direction identification information stored in the connection distance information maintaining unit 17 enable identifying location of the failure point as the PON system by being notified to the control unit 11.

As described above, the present embodiment proves the OLT with the distance measuring function, and uses a light source having a wavelength different from those of normal PON up, down, or VIDEO signals in the distance measuring function unit. These features provide such advantages as follows.

A first advantage is the ability to minimize influence on ONUs 4 that are performing communication and eliminate wasting of a bandwidth when the ONU 4 is activated by minimizing the time for which other ONUs in the same PON system are once halted when the ONU 4 is activated or a periodical stop time associated with activation of the ONU 4. Therefore, according to the present embodiment, it is possible to minimize influence on other ONUs in service even when a single ONU is activated and provide a communication bandwidth as efficient as possible to a telecommunication provider.

A second advantage is that time to recovery from a failure can be significantly shortened because the point of a failure can be located as a PON system when a failure, such as a line disconnection, has occurred between the PON 1 and the ONU 4.

That is, in a conventional method for locating the point of a failure when a failure such as a line disconnection of optical fiber has occurred between the OLT 1 and a particular ONU, a maintenance person should connect measuring equipment for locating the point of a failure to a PON line and carry out measurement. Such a method thus has the problem of requiring some time before locating the point of the failure. According to the present embodiment, it is possible to provide a telecommunication provider with a PON system that is capable of quickly locating the point of a failure in the event of a line failure as described above.

A third advantage is the ability to measure the distance between the OLT 1 and an ONU 4 which is activated or the distance from the OLT 1 to the point of a failure without stopping currently provided services by a using light source in the measurement function unit that has a wavelength different from those of typical up and down signals.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

For example, when a PON system which is characterized by eliminating wasting of bandwidth at the time of ONU 4 activation is constructed in the embodiment described above, the connection distance measuring unit 16 may not be included. In other words, the present invention is similarly applicable to a configuration in which the distance between an OLT and ONUi is separately measured by other device or the like as mentioned above and distance information is prestored in the connection distance information maintaining unit 17.

Also, by recording a processing procedure for realizing operations of the OLT 1 and the PON system according to the above-described embodiment in a recording medium as a program, the above-described functions according to the embodiment of the present invention can be realized by causing a CPU of a computer configuring the system to perform processing with the program supplied from the recording medium. In this case, the present invention is also applicable when pieces of information including the program are supplied to an output device from the recording medium or from an external recording medium via a network.

That is to say, program code read out from the recording medium itself realizes the novel features of the present invention and the recording medium on which the program code is stored and signals read from the recording medium configure the present invention. The recording medium may be a. flexible disk, hard disk, optical disk, magneto-optical disk, CD-ROM, CD-R, CD-RW, DVD-ROM, DVD-RAM, DVD-RW, DVD+RW, magnetic tape, non-volatile memory card, ROM, or the like, for example.

With the recording medium recording the program according to the present invention, it is possible to cause an OLT and/or a PON system that are controlled by the recorded program to realize functions of the embodiment described above.

As has been described, according to the present invention, influence on other ONUs in service can be reduced and communication bandwidth can be effectively utilized even when a single ONU is activated.

What is claimed is:

1. A station terminal device, comprising:
a first distance information storing unit that stores distance information on a distance to a subscriber terminal device in association with identification information that identifies the subscriber terminal device; and
an activation control unit that uses distance information stored in the first distance information storing unit to control activation of a subscriber terminal device that is identified by identification information associated with the distance information.

2. The station terminal device according to claim 1, further comprising:
a communication unit that communicates with the subscriber terminal device; and
a distance measuring unit that performs distance measurement using a signal of a wavelength different from a wavelength that is predefined as a wavelength used by the communication unit for communication.

3. The station terminal device according to claim 2, wherein information stored by the first distance information storing unit includes information that associates distance information which is a result of measurement by the distance measuring unit with identification information which identifies a subscriber terminal device as a target of the distance measurement.

4. The station terminal device according to claim 2, wherein the wavelength that is predefined as a wavelength used by the communication unit for communication includes at least wavelengths for an up signal and a down signal.

5. The station terminal device according to claim 2, wherein the distance measuring unit performs distance measurement with the signal of a different wavelength by including a light source that is different from a light source of the communication unit.

6. The station terminal device according to claim 2, further comprising
a monitoring unit that monitors line disconnections on a communication line, wherein
the distance measuring unit, upon receiving an alarm signal indicating occurrence of a line disconnection between the station terminal device and the subscriber terminal device from the monitoring unit, measures the distance to a point of the line disconnection.

7. The station terminal device according to claim 6, wherein after measurement of the distance to the point of the line disconnection, the distance measuring unit stores distance information which is the result of the measurement in a second distance information storing unit in association with direction identification information which identifies a subscriber terminal device in a direction in which the distance measurement was performed.

8. A communication system comprising the station terminal device according to claim 1 connected with the subscriber terminal device via a transmission channel.

9. A subscriber device management method, comprising:
a first distance information storing step of storing distance information on a distance to a subscriber terminal device in association with identification information that identifies the subscriber terminal device; and
an activation control step of using distance information stored at the first distance information storing step to control activation of a subscriber terminal device that is identified by identification information associated with the distance information.

10. The subscriber device management method according to claim 9, further comprising a first distance measuring step of performing distance measurement using a signal of a wavelength different from a wavelength that is predefined as a wavelength for use in communication with the subscriber terminal device.

11. The subscriber device management method according to claim 10, wherein at the first distance information storing step, distance information which is a result of measurement at the first distance measuring step is stored in association with identification information which identifies a subscriber terminal device as a target of the distance measurement.

12. The subscriber device management method according to claim 10, wherein the wavelength that is predefined as a wavelength for use in communication with the subscriber terminal device includes at least wavelengths for an up signal and a down signal.

13. The subscriber device management method according to claim 10, wherein at the first distance measuring step, distance measurement is performed with the signal of a different wavelength by using a light source that is different from a light source used in communication with the subscriber terminal device.

14. The subscriber device management method according to claim 9, further comprising:
a monitoring step of monitoring line disconnections on a communication line; and
a second distance measuring step of, if an alarm signal indicating occurrence of a line disconnection on a communication line to the subscriber terminal device is received at the monitoring step, measuring the distance to a point of the line disconnection.

15. The subscriber device management method according to claim 14, further comprising a second distance information storing step of, after measurement of the distance to the point of the line disconnection is performed at the second distance measuring step, storing distance information which is the result of the measurement in association with direction identification information which identifies a subscriber terminal device in the direction in which the distance measurement was performed.

16. A recording medium recording a program for a station terminal device, the program causing a computer to execute:
a first distance information storing process for storing, in a storing unit, distance information on a distance to a subscriber terminal device in association with identification information that identifies the subscriber terminal device; and
an activation control process for using distance information stored in the first distance information storing process to control activation of a subscriber terminal device that is identified by identification information associated with the distance information.

17. The recording medium recording a program for a station terminal device according to claim 16, wherein the program causes the computer to execute a first distance measuring process for measuring a distance using a signal of a wavelength different from a wavelength that is predefined as a wavelength for use in communication with the subscriber terminal device.

18. The recording medium recording a program for a station terminal device according to claim 17, wherein the first distance information storing process stores distance information which is a result of measurement in the first distance measuring process in association with identification information which identifies a subscriber terminal device as a target of the distance measurement.

19. The recording medium recording a program for a station terminal device according to claim 17, wherein the wavelength that is predefined as a wavelength for use in communication with the subscriber terminal device includes at least wavelengths for an up signal and a down signal.

20. The recording medium recording a program for a station terminal device according to claim 17, wherein the first distance measuring process performs distance measurement with the signal of a different wavelength by using a light source that is different from a light source used in communication with the subscriber terminal device.

21. The recording medium recording a program for a station terminal device according to claim 16, wherein the program causes the computer to execute:
a monitoring process of monitoring line disconnections on a communication line; and
a second distance measuring process of, if an alarm signal indicating occurrence of a line disconnection between the station terminal device and the subscriber terminal device is received in the monitoring process, measuring the distance to a point of the line disconnection.

22. The recording medium recording a program for a station terminal device according to claim 21, wherein the program causes the computer to execute a second distance information storing process of, after measurement of the distance to the point of the line disconnection is performed in the second distance measuring process, storing, in a storing unit, distance information which is the result of the measurement in association with direction identification information which identifies a subscriber terminal device in the direction in which the distance measurement was performed.

23. A station terminal device, comprising:
first distance information storing means for storing distance information on a distance to a subscriber terminal device in association with identification information that identifies the subscriber terminal device; and
activation control means for using distance information stored in the first distance information storing means to control activation of a subscriber terminal device that is identified by identification information associated with the distance information.
